(19) United States
(12) Patent Application Publication
(10) Pub. No.: US 2024/0336802 A1
(43) Pub. Date: Oct. 10, 2024

(54) WATERBORNE COATING COMPOSITIONS BASED ON ACRYLIC GRAFTED TMA- MODIFIED UNSATURATED POLYESTERS

(71) Applicant: Eastman Chemical Company, Kingsport, TN (US)

(72) Inventors: Katelyn Rose Houston, Johnson City, TN (US); Thauming Kuo, Kingsport, TN (US); Hongkun He, Kingsport, TN (US); Stacey James Marsh, Church Hill, TN (US)

(73) Assignee: Eastman Chemical Company, Kingsport, TN (US)

(21) Appl. No.: 18/577,763

(22) PCT Filed: Jul. 13, 2022
(86) PCT No.: PCT/US2022/036899

§ 371 Date: Jan. 9, 2024

Related U.S. Application Data
(60) Provisional application No. 63/203,249, filed on Jul. 14, 2021.

(51) Int. Cl. C09D 151/08; C08F 283/01; C08G 63/553; C08G 63/85

(52) U.S. Cl. CPC C09D 151/08; C08F 283/01; C08G 63/553; C08G 63/85

(57) ABSTRACT

Disclosed are novel curable acrylic modified polyesters comprising the reaction product of 2,2,4,4-tetramethyl-1,3-cyclo butanediol (TMCD) modified by a polycarboxylic acid anhydride. The curable acrylic modified polyesters have particular utility for use in waterborne coating compositions containing a crosslinker. Such waterborne coating compositions provide a good balance of desirable coating properties for metal packaging applications.

### FIELD OF THE INVENTION

This invention relates to curable acrylic modified polyesters comprising unsaturated polyester compositions that are modified by a polycarboxylic acid anhydride. More particularly, this invention relates to improved unsaturated polyester compositions comprising 2,2,4,4-tetramethyl-1,3-cyclobutanediol (TMCD). Waterborne coating compositions prepared from such acrylic modified polyesters are capable of providing a good balance of desirable coating properties for metal packaging applications.

### BACKGROUND OF THE INVENTION

Metal containers are commonly used for food and beverage packaging. The containers are typically made of steel or aluminum. A prolonged contact between the metal and the filled product can lead to corrosion of the container. To prevent direct contact between filled product and metal, a coating is typically applied to the interior of the food and beverage cans. In order to be effective, such a coating must have certain properties that are needed for protecting the packaged products and the integrity of the metal container, such as adhesion, corrosion resistance, chemical resistance, flexibility, stain resistance, and hydrolytic stability. Moreover, the coating must be able to withstand processing conditions during can fabrication and food sterilization. Coatings based on a combination of epoxy and phenolic resins are known to be able to provide a good balance of the required properties and are most widely used. Some industry sectors are moving away from food contact polymers made with bisphenol A (BPA), a basic building block of epoxy resins. Thus, there exists a need for non-BPA containing coatings for use in interior can coatings.

Polyester resins are of particular interest to the coating industry as replacements for epoxy resins because of their comparable properties such as flexibility and adhesion. 2,2,4,4-Tetramethyl-1,3-cyclobutanediol (TMCD) is a cycloaliphatic compound that can be used as a diol component for making polyesters. Thermoplastics based on TMCD polyester exhibit improved impact resistance owing to TMCD's unique structure. TMCD can also provide improved hydrolytic stability of the polyester due to its secondary hydroxyl functionality. Both of these properties are highly desirable in thermosetting coatings.

Coatings based on TMCD polyesters have been of interest to replace epoxy resins for interior can coating application. Prior efforts have been directed to coating systems based on high Tg, mid-molecular weight TMCD polyesters with slight crosslinking in order to withstand processing conditions during can fabrication. Such systems, however, have been found to have shortcomings in some of the desired properties such as corrosion resistance, retort resistance, and microcracking (crazing) resistance. Higher crosslinking can lead to improved coating properties such as corrosion resistance, acid resistance, stain resistance, and retort resistance. Such coatings, however, tend to be less flexible, which can have detrimental effects on microcracking resistance and bending ability during processing.

Thus, it is desirable to innovate a coating system that can provide a good balance of the properties required for the intended application. It is known in the art that acrylic polymer can remedy the shortcoming of the polyester in properties such as hydrolytic stability, chemical resistance, and thermal stability. The improvement in these properties is particularly desirable for waterborne polyester systems due to the vulnerability of its ester linkages to hydrolysis and acid/base attack.

An object of this invention is to provide an acrylic modified polyester for waterborne coating applications. In particular, this invention provides an acrylic modified polyester, wherein the polyester comprises TMCD as a diol component and trimellitic anhydride as a modifier for waterborne formulations. Such a coating system is unique in that the polyester moieties can simultaneously provide high molecular weights, effective hydroxyl functionality for crosslinking, and sufficient carboxyl groups for water dispersibility. By utilizing this unique feature, the waterborne composition of the present invention can be readily tuned to obtain the desirable coating properties that otherwise cannot be achieved. For example, polyesters used for metal packaging coatings are typically designed to have hydroxyl number lower than 30 KOH/mg and acid number lower than 5 mgKOH/g in order to obtain the high molecular weights required for can fabrication. This, however, has created a barrier for waterborne formulations due to lack of sufficient carboxyl end groups for neutralization to impart water dispersibility. A breakthrough in the technology has thus become much desirable to break this deadlock.

### SUMMARY OF THE INVENTION

This invention discloses a waterborne coating composition comprising:
I. an acrylic modified polyester, which is the reaction product of an unsaturated polyester having α,β-unsaturated moieties prepared from monomers including a polycarboxylic acid anhydride having three or more carboxyl groups and one or more ethylenically unsaturated monomers, and
II. a crosslinker;
wherein said unsaturated polyester has an acid number of 5 to 30 mgKOH/g, hydroxyl number of 6 to 30 mgKOH/g, number average molecular weight of 4,000 to 25,000 g/mole, and weight average molecular weight of 13,000 to 200,000 g/mole; and wherein said unsaturated polyester is reacted with said ethylenically unsaturated monomers through said α,β-unsaturated moieties.

In another embodiment, the invention is a waterborne coating composition comprising:
I. an acrylic modified polyester, which is the reaction product of
   a. an unsaturated polyester having α,β-unsaturated moieties prepared by reacting the monomers comprising:
      i. 2,2,4,4-tetramethyl-1,3-cyclobutanediol (TMCD) in an amount of 30 to 60 mole %, based on the total moles of i-iii,
      ii. a diol other than TMCD in an amount of 40 to 70 mole %, based on the total moles of i-iii,
      iii. a triol in an amount of 0 to 8 mole %, based on the total moles of i-iii,
      iv. an α,β-unsaturated diacid or anhydride in an amount of 1 to 20 mole %, based on the total moles of iv-vii,
      v. an aromatic diacid in an amount of 45 to 98 mole %, based on the total moles of iv-vii,
      vi. an aliphatic diacid in an amount of 0 to 20 mole %, based on the total moles of iv-vii, and
      vii. trimellitic anhydride (TMA) in an amount of 1 to 15 mole %, based on the total moles of iv-vii, and
   b. one or more ethylenically unsaturated monomers
II. a crosslinker,
   wherein said unsaturated polyester has an acid number of 5 to 30 mgKOH/g, hydroxyl number of 6 to 30 mgKOH/g, number average molecular weight of 4,000 to 25,000 g/mole, and weight average molecular weight of 13,000 to 200,000 g/mole; and wherein said unsaturated polyester is reacted with said ethyleneically unsaturated monomers through said α,β-unsaturated moieties.

### DETAILED DESCRIPTION

### Definitions

In this specification and in the claims that follow, reference will be made to a number of terms, which shall be defined to have the following meanings.

“Acrylic” means ethylenically unsaturated monomer derivatives of acrylic and methacrylic acid.

“Alkyl” means an aliphatic hydrocarbon. The alkyl can specify the number of carbon atoms, for example (C₁₋₅)alkyl. Unless otherwise specified, the alkyl group can be unbranched or branched. In one embodiment, the alkyl group is branched. In one embodiment, the alkyl group is unbranched. Non-limiting examples of alkanes include methane, ethane, propane, isopropyl (i.e., branched propyl), butyl, and the like.

“Alcohol” means a chemical containing one or more hydroxyl groups.

“Aldehyde” means a chemical containing one or more —C(O)H groups.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

“Chosen from” as used herein can be used with “or” or “and.” For example, Y is chosen from A, B, and C means Y can be individually A, B, or C. Alternatively, Y is chosen from A, B, or C means Y can be individually A, B, or C; or a combination of A and B, A and C, B and C, or A, B, and C.

Disclosed herein is an unexpected discovery that waterborne coating compositions based on acrylic modified polyesters comprising 2,2,4,4-tetramethyl-1,3-cyclobutanediol (TMCD) as a diol component and trimellitic anhydride (TMA) as a modifier are capable of providing desirable coating properties for various applications particularly in metal packaging.

Thus, in one embodiment of the invention, there is provided a waterborne coating composition comprising:
I. an acrylic modified polyester, which is the reaction product of
   a. an unsaturated polyester having α,β-unsaturated moieties prepared from monomers including a polycarboxylic acid anhydride having three or more carboxyl groups and
   b. one or more ethylenically unsaturated monomers, and
II. a crosslinker,
wherein said unsaturated polyester has an acid number of 5 to 30 mgKOH/g, hydroxyl number of 6 to 30 mgKOH/g, number average molecular weight of 4,000 to 25,000 g/mole, and weight average molecular weight of 13,000 to 200,000 g/mole; and wherein said unsaturated polyester is reacted with said ethyleneically unsaturated monomers through said α,β-unsaturated moieties.

In another embodiment this invention provides a waterborne coating composition comprising:
I. an acrylic modified polyester, which is the reaction product of
   a. an unsaturated polyester having α,β-unsaturated moieties prepared by reacting the monomers comprising:
      i. 2,2,4,4-tetramethyl-1,3-cyclobutanediol (TMCD) in an amount of 30 to 60 mole %, based on the total moles of i-iii,
      ii. a diol other than TMCD in an amount of 40 to 70 mole %, based on the total moles of i-iii,
      iii. a triol in an amount of 0 to 8 mole %, based on the total moles of i-iii,
      iv. an α,β-unsaturated diacid or anhydride in an amount of 1 to 20 mole %, based on the total moles of iv-vii,
      v. an aromatic diacid in an amount of 45 to 98 mole %, based on the total moles of iv-vii,
      vi. an aliphatic diacid in an amount of 0 to 20 mole %, based on the total moles of iv-vii, and
      vii. trimellitic anhydride (TMA) in an amount of 1 to 15 mole %, based on the total moles of iv-vii, and
   b. one or more ethylenically unsaturated monomers, and
II. a crosslinker,
wherein said unsaturated polyester has an acid number of 5 to 30 mgKOH/g, hydroxyl number of 6 to 30 mgKOH/g, number average molecular weight of 4,000 to 25,000 g/mole, and weight average molecular weight of 13,000 to 200,000 g/mole; and wherein said unsaturated polyester is reacted with said ethylenically unsaturated monomers through said α,β-unsaturated moieties.

In some embodiments of the invention, said 2,2,4,4-tetramethyl-1,3-cyclobutanediol (TMCD) (i) is in an amount of 35-58 mole %, said diol other than TMCD (ii) in an amount of 42 to 65 mole %, said triol (iii) in an amount of 0 to 5 mole %, said α,β-unsaturated diacid or anhydride (iv) in an amount of 3 to 18 mole, said aromatic diacid (v) in an amount of 54 to 94 mole %, said aliphatic diacid (vi) in an amount of 0 to 15 mole %, and said TMA in an amount of 3-13 mole %.

In further embodiments, said 2,2,4,4-tetramethyl-1,3-cyclobutanediol (TMCD) (i) is in an amount of 40-50 mole %, said diol other than TMCD (ii) in an amount of 50 to 60 mole %, said triol (iii) in an amount of 0 to 3 mole %, said α,β-unsaturated diacid or anhydride (iv) in an amount of 5 to 15 mole, said aromatic diacid (v) in an amount of 65 to 90 mole %, said aliphatic diacid (vi) in an amount of 0 to 10 mole %, and said TMA in an amount of 5-10 mole %.

In other aspects, said 2,2,4,4-tetramethyl-1,3-cyclobutanediol (TMCD) is in an amount of 30-60, 32-58, 35-55, 37-53, 40-50, or 42-48 mole %, based on the total moles of i-iii.

In further aspects, said diol other than TMCD is in an amount of 40-70, 40-65, 42-65, 42-63, 45-61, 47-60, or 50-60 mole %, based on the total moles of i-iii.

In other aspects, said triol is in an amount of 0-8, 0-7, 0-6, 0-5, 0-4, 0-3, 1-8, 1-7, 1-6, 1-5, 1-4, 1-3, 1-2, 2-8, 2-7, 2-6, 2-5, 2-4, 2-3, 3-8, 3-7, 3-6, 3-5, 3-4, 4-8, 4-7, 4-6, 4-5, 5-8, 5-7, 5-6, 6-8, 6-7, or 7-8 mole %, based on the total moles of i-iii.

In other aspects, said α,β-unsaturated diacid or anhydride is in an amount of 1-20, 2-19, 3-18, 4-17, 5-15, 6-15, 7-15, 8-15, 9-15, 10-15, 1-3, 1-5, 1-8, 1-10, 2-5, 3-7, or 5-10 mole %, based on the total moles of iv-vii,

In other aspects, said aromatic diacid is in an amount of 45-98, 50-96, 54-94, 55-92, 60-91, or 65-90 mole %, based on the total moles of iv-vii,

In other aspects, said aliphatic diacid is in an amount of 0-20, 0-18, 0-15, 0-10, 0-5, 5-25, 5-20, 5-15, 5-10, 10-20, 10-15, or 15-20 mole %, based on the total moles of iv-vii.

In other aspects, said TMA is in an amount of 1-15, 2-14, 3-13, 4-12, or 5-10 mole %, based on the total moles of iv-vii.

Examples of the diol other than TMCD (ii) include 1,4-cyclohexanedimethanol, 1,3-cyclohexanedimethanol, 1,2-cyclohexanedimethanol, 1,6-hexanediol, 1,4-butanediol, 2-methyl-1,3-propanediol, neopentyl glycol, hydroxypivalyl hydroxypivalate, 2-butyl-2-ethyl-1,3-propanediol, 2,2,4-trimethyl-1,3-pentanediol, and mixtures thereof. In some embodiments, said diol (ii) is selected from 1,4-cyclohexanedimethanol, 1,3-cyclohexanedimethanol, 1,6-hexanediol, 2-methyl-1,3-propanediol, neopentyl glycol, 2,2,4-trimethyl-1,3-pentanediol. and mixtures thereof.

Examples of the triol include 1,1,1-trimethylolpropane, 1,1,1-trimethylolethane, glycerol, and mixtures thereof. Desirably, the triol is 1,1,1-trimethylolpropane.

Examples of α,β-unsaturated diacid or anhydride (iv) include maleic acid or its anhydride, crotonic acid or its anhydride, itaconic acid or its anhydride, citraconic acid or its anhydride, mesaconic acid, phenylmaleic acid or its anhydride, t-butyl maleic acid or its anhydride, and mixtures thereof. Desirably, said α,β-unsaturated diacid or anhydride (iv) is one or more selected from the group consisting of maleic anhydride, maleic acid, fumaric acid, itaconic anhydride, and itaconic acid. It should be noted that the aforementioned diacids include their monoester and diesters such as, for example, dimethyl maleate and dimethyl fumarate.

Examples of said aromatic diacid (v) include isophthalic acid and its esters, such as dimethyl isophthalate, and terephthalic acid and its esters such as dimethyl terephthalate.

Said aliphatic diacid (vi) includes C₄-C₁₂ diacids and their esters. These aliphatic diacids (vi) do not include the α,β-unsaturated diacid or anhydride designated as (iv) above. Examples of aliphatic acid include succinic acid, adipic acid, sebacic acid, dodecanedioic acid, 1,4-cyclohexane dicarboxylic acid, 1,3-cyclohexane dicarboxylic acid, 1,2-cyclohexane dicarboxylic acid, and their methyl esters; and (hydrogenated) dimer acid (C₃₆). Desirably, when longer chain diacids (>C₁₀) are used, they are at a smaller ratio such as 1-5, 1-4, 1-3, or 1-2 mole %. In some embodiments, said aliphatic diacid is one or more selected from succinic acid, adipic acid, sebacic acid, 1,4-cyclohexane dicarboxylic acid, and 1,3-cyclohexane dicarboxylic acid. Desirably, said aliphatic diacid is sebacic acid, adipic acid, or a mixture thereof.

Said polycarboxylic acid anhydride has one or more carboxylic acid groups in addition to an anhydride group. An example is trimellitic anhydride (TMA).

Said unsaturated polyester is prepared first by polycondensation of the monomers (i)-(vi) to yield hydroxyl end groups, followed by the reaction of the hydroxyl end group with the anhydride group on TMA to yield two carboxylic acid end groups. By doing that, the acid number of the unsaturated polyester can be tuned to the desirable number for the improvement of the acrylic modified polyester properties such as its aqueous dispersion stability.

Said unsaturated polyester has a glass transition temperature (Tg) of 40-110° C., 40-100° C., 40-90° C., 40-80° C., 45-100° C., 50-100° C., 55-100° C., 60-100° C., 65-100° C., 45-90° C., 50-90° C., 55-90° C., 60-90° C., 65-90° C., 70-90° C., 50-80° C., 55-80° C., or 60-80° C.

Said unsaturated polyester has an acid number of 5-30, 6-28, 7-25, 8-24, 9-22, or 10-20 mgKOH/g.

Said unsaturated polyester has a hydroxyl number of 6-30, 6-28, 6-25, 8-25, 10-25, 12-25, 14-25, 8-23, 10-23, 12-23, 14-23, 10-20, 12-20, 14-20, 16-20, 10-18, 12-18, 14-18, 10-16, or 12-16 mgKOH/g.

Said unsaturated polyester has a number average molecular weight of 4,000-25,000, 5,000-25,000, 5,000-20,000, 5,000-15,000, 5,000-13,000, 5,000-10,000, 6,000-15,000, 7,000-15,000, 7,000-13,000, or 7,000-10,000 g/mole; weight average molecular weight of 13,000-200,000, 14,000-150,000, 15,000-150,000, 20,000-140,000, 25,000-130,000, 30,000-110,000, 23,000-140,000, 28,000-120,000, 15,000-20,000, 15,000-30,000, 15,000-40,000, or 15,000-50,000 g/mole.

Said unsaturated polyester is synthesized in the presence of a catalyst. Examples of suitable catalysts include those based on titanium, tin, gallium, zinc, antimony, cobalt, manganese, germanium, alkali metals, particularly lithium and sodium, alkaline earth compounds, aluminum compounds, combinations of aluminum compounds with lithium hydroxide or sodium hydroxide, and mixtures of. In one embodiment, the catalyst is based on titanium or tin.

Examples of suitable titanium compounds include titanium(IV) 2-ethylhexyloxide (e.g., Tyzor® TOT), titanium(IV) (triethanolaminato)isopropoxide (e.g., Tyzor® TE), tetraisopropyl titanate, titanium diisopropoxide bis(acetylacetonate), and tetrabutyl titanate (e.g., Tyzor® TBT). Examples of suitable tin compounds include butyltin tris-2-ethylhexanoate, butylstannoic acid, stannous oxalate, dibutyltin oxide.

Suitable ethylenically unsaturated monomers include acrylic acid, methacrylic acid, methyl methacrylate, methyl acrylate, ethyl methacrylate, ethyl acrylate, n-butyl acrylate, n-hexyl acrylate, n-hexyl methacrylate, 2-methoxyethyl acrylate, 2-ethylhexyl acrylate, 2-ethylhexyl methacrylate, isobutyl acrylate, isobutyl methacrylate, n-octyl acrylate, n-octyl methacrylate, iso-octyl acrylate, and iso-octyl methacrylate. 2-hydroxyethyl (meth) acrylate, 2-hydroxypropyl (meth)acrylate, glycidyl (meth)acrylate, acetoacetoxy ethyl methacrylate, acetoacetoxy ethyl acrylate, and styrene.

In a further embodiment, said ethylenically unsaturated monomers are selected from the group comprising acrylic acid, methacrylic acid, methyl methacrylate, methyl acrylate, ethyl methacrylate, ethyl acrylate, n-butyl acrylate, 2-ethylhexyl acrylate, 2-hydroxyethyl methacrylate, and styrene.

In some embodiments, said acrylic modified polyester (I) comprises said unsaturated polyester (a) in an amount of 10-90, 15-85, 20-80, 25-75, 30-70, 35-65, 40-60, or 45-55 weight % and said ethylenically unsaturated monomers (b) in an amount of 90-10, 85-15, 80-20, 75-25, 70-30, 65-35, 60-40, or 55-45 weight %, based on the total weight of (a) and (b).

As further embodiments, said acrylic modified polyester has an acid number of 25-70, 30-65, 35-60, 40-55, 45-50 mgKOH/g, hydroxyl number of 15-50, 20-45, 25-40, 20-40, 30-45, or 30-40 mgKOH/g, number average molecular weight of 4,000-25,000, 5,000-25,000, 5,000-20,000, 5,000-15,000, 5,000-13,000, 5,000-10,000, 6,000-15,000, 7,000-15,000, 7,000-13,000, or 7,000-10,000 g/mole; weight average molecular weight of 13,000-200,000, 14,000-150,000, 15,000-150,000, 20,000-140,000, 25,000-130,000, 30,000-110,000, 23,000-140,000, 28,000-120,000, 15,000-20,000, 15,000-30,000, 15,000-40,000, or 15,000-50,000 g/mole.

The process of preparing the acrylic modified polyester of the present invention comprises (1) reacting the reactants (i), (ii), (iii), (iv), (v), (vi), and (vii) above under polycondensation conditions to produce the unsaturated polyester (a), and (2) reacting under bulk or solution-addition-copolymerization conditions about 10 to 90 weight percent of the polyester made in step (1) with about 10 to 90 weight percent of at least one ethylenically unsaturated monomer. The reaction in step (2) is preferably conducted under bulk or solution addition-copolymerization conditions at a temperature of about 60 to 150° C. under inert atmosphere in the presence of a free radical initiator. The free-radical initiator is preferably in a suspension, such as initiator in alcohol. The free-radical initiator employed in this second step is selected from organic peroxides or azo compounds, such as benzoyl peroxide, t-butyl hydroperoxide, t-butyl peroxide, t-butyl peroxybenzoate, azobisisobutyronitrile, and 2,2′-azobis(2,4-dimethyl)-valeronitrile. The free radical polymerization reaction is most preferably carried out at the reflux temperature of the solvent used which is generally higher than the thermal decomposition temperature of the initiator employed. The water miscible solvents used in this free-radical polymerization include sec-butanol, isobutanol, isopropanol, n-propanol, ethanol, ethylene glycol monobutyl ether, propylene glycol n-butyl ether, propylene glycol methyl ether, propylene glycol monopropyl ether, dipropylene glycol methyl ether, and diacetone alcohol.

In a further embodiment, this invention provides an aqueous dispersion of an acrylic modified polyester comprising:
a) an acrylic modified polyester of this invention,
b) a neutralizing agent, and
c) water.

The neutralizing agent may be an amine or an inorganic base. Typical amines include ammonia, trimethylamine, diethylamine, monoethanolamine, monoisopropanolamine, morpholine, ethanolamine, diethanolamine, triethanolamine, N,N-dimethylethanolamine, N, N-diethylethanolamine, N-methyldiethanolamine and the like.

Typical inorganic bases include bases derived from alkali metals and alkaline earth metals such as, for example, sodium, potassium, magnesium, calcium, and other basic metal compounds. Suitable bases from this first class of bases useful in the present invention include, but are not limited to, sodium oxide, potassium oxide, magnesium oxide, calcium oxide, sodium hydroxide, potassium hydroxide, magnesium hydroxide, calcium hydroxide, sodium carbonate, potassium carbonate, sodium bicarbonate, potassium bicarbonate, calcium carbonate, magnesium bicarbonate, alkali metal borate compounds and their hydrates, sodium phosphate, potassium biphosphate, and sodium pyrophosphate.

The aqueous dispersion of this invention may further comprise an organic co-solvent. Suitable co-solvents include ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diacetone alcohol, and other water-miscible solvents.

An aqueous dispersion of the acrylic-modified polyester is preferably stable. Stability is defined as the absence of polymer coagulation or phase separation of an aqueous dispersion (15 to 80 weight percent solids) after shelf storage for a minimum of three months at 20 to 30° C.

The particular acrylic-modified polyester can be isolated neat; however, it is desirable for typical material handling purposes to prepare a dispersion or solution of the acrylic modified polyester. This dispersion or solution comprises 10 to 50 weight percent of liquid which comprises 0 to 90 weight percent water and 0 to 100 weight percent of a suitable oxygen containing organic solvent such as alcohols, ketones, esters, and ethers, preferred are low molecular weight alcohols such as C₁ to C₁₀ alcohols, e.g., ethanol, n-propanol, iso-propanol, and iso-butanol. Such a dispersion can be used as a coating composition or can be used as a pre-dispersion to prepare a coating composition.

The coating composition of the present invention comprises (A) about 50 to 90 weight percent, based on the total weight of the acrylic modified polyester and the crosslinking agent, of the acrylic-modified polyester above, (B) about 30 to 70 percent, based on the weight of the total coating composition, of water, (C) about 0 to 10 percent, based on the total weight of the coating composition, of a suitable organic solvent, and (D) about 10 to 50 weight percent of a crosslinking agent, based on the total weight of the acrylic modified polyester and the crosslinking agent.

As appreciated in the art, the exact components and properties of components desired for any given coating application can vary, and therefore, routine experimentation may be required to determine the optional components and proportions of components for a given application and desired properties.

In another embodiment, the coating composition of the present invention comprises said acrylic modified polyester (a) in an amount of 50-90 weight % and said crosslinker (b) in an amount of 10-50 weight %, based on the total weight of (a) and (b). In some embodiments, the polyester polyol (a) is in 55-85, 60-80, 65-85, 65-80, 65-75, 70-90, 70-85, 70-80, 75-85, 80-90, or 80-85 weight %; and the crosslinker (b) in 15-45, 20-40, 15-35, 20-35, 25-35, 10-30, 15-30, 20-30, 15-25, 10-20, or 15-20 weight %, based on the total weight of (a) and (b).

Said crosslinker (b) is one or more crosslinker selected from the group comprising isocyanate, amino resin, and phenolic resin crosslinkers or mixtures thereof. Desirably, the crosslinker is isocyanate, amino, or a mixture thereof.

The isocyanate crosslinker suitable for this invention may be blocked or unblocked isocyanate type. Examples of suitable isocyanate crosslinkers include, but are not limited to, 1,6-hexamethylene diisocyanate, methylene bis(4-cyclohexyl isocyanate), and isophorone diisocyanate. Desirably, the isocyanate crosslinker is isophorone diisocyanate (IPDI) or blocked IPDI available from COVESTRO as Desmodur® BL 2078/2. Bayhydur® 3100 available from COVESTRO is a hydrophilic aliphatic polyisocyanate based on hexamethylene diisocyanate (HDI); it is particularly suitable for waterborne formulations.

In addition to isocyanate, said crosslinker (b) may also be an amino resin. The amino resin crosslinker (or cross-linking agent) can be a melamine-formaldehyde type or benzoguanamine-formaldehyde type cross-linking agent, i.e., a cross-linking agent having a plurality of —N(CH₂OR₃)₂ functional groups, wherein R³ is C₁-C₄ alkyl, preferably methyl.

In still another embodiment, the crosslinker (b) is a mixture of amino resin in an amount of 20-80 weight % and isocyanate in an amount of 80-20 weight %, based on the total weight of the crosslinkers.

In general, the amino cross-linking agent may be selected from compounds of the following formulae, wherein R³ is independently C₁-C₄ alkyl:

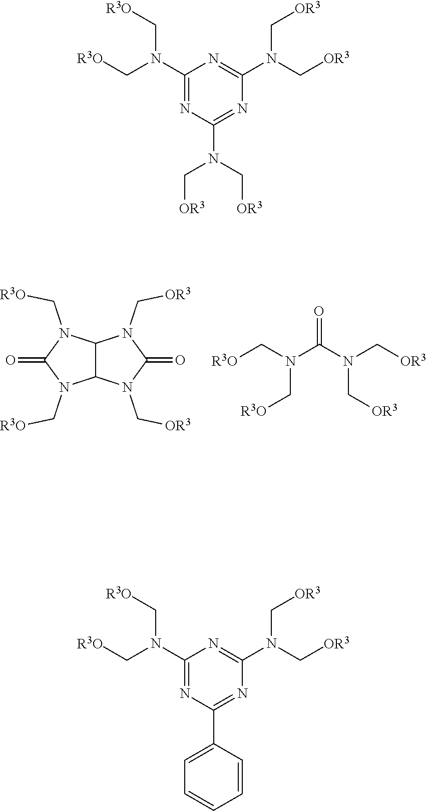

The amino containing cross-linking agents are desirably hexamethoxymethylmelamine, hexabutoxymethylmelamine, tetramethoxymethylbenzoguanamine, tetrabutoxymethylbenzoguanamine, tetramethoxymethylurea, mixed butoxy/methoxy substituted melamines, and the like. Suitable commercial amino resins include Maprenal BF 987 (n-butylated benzoquanamine-formaldelhyde resin available from Ineos), Cymel 1123 (highly methylated/ethylated benzoguanamine-formaldehyde resin available from Allnex), Cymel 1158 (butylated melamine-formaldehyde resin with amino functionality available from Allnex), Cymel 325 (methylated high imino melamine resin available from Allnex), and other benzoquanamine-formaldelhyde and melamine-formaldehyde resins.

In one embodiment, said crosslinker (b) is a mixture of Maprenal BF 987 and Cymel 325.

Besides isocyanate and amino crosslinkers, said crosslinker (b) may also be a phenolic resin; desirably the phenolic resin is a resole phenolic resin.

Said resole phenolic resin contains the residues of un-substituted phenol and/or meta-substituted phenols. These particular resole resins exhibit good reactivity with said polyester polyol (a). Desirably, the amount of the resole phenolic resin is at least 50 wt. %, or greater than 60 wt. %, or greater than 70 wt. %, or greater than 80 wt. %, or greater than 90 wt. %, based on the weight of all cross-linker compounds in the resin.

The resole phenolic resin present in the crosslinking composition contains methylol groups on the phenolic rings. Phenolic resins having methylol functionalities are referred to as resole type phenolic resins. As is known in the art, the methylol group (—CH₂OH) may be etherated with an alcohol and present as —CH₂OR, wherein R is C₁-C₈ alkyl group, in order to improve resin properties such as storage stability and compatibility. For purpose of the description, the term “methylol” used herein includes both —CH₂OH and —CH₂OR and an un-substituted methylol group is CH₂OH. Said methylol groups (either —CH₂OH or —CH₂OR) are the end groups attached to the resole resins. The methylol groups are formed during the resole resin synthesis and can further react with another molecule to form ether or methylene linkages leading to macromolecules.

The phenolic resin contains the residues of un-substituted phenols or meta-substituted phenols. When starting with phenol or meta-substituted phenols to make a resole, the para and ortho positions are both available for bridging reactions to form a branched network with final methylol end groups on the resin being in the para or ortho positions relative to the phenolic hydroxyl group. To make the phenolic resole, a phenol composition is used as a starting material. The phenol composition contains un-substituted and/or meta-substituted phenols. The amount of un-substituted, meta-substituted, or a combination of the two, that is present in the phenol compositions used as a reactant to make the phenolic resole resin, is at least 50 wt. %, or at least 60 wt. %, or at least 70 wt. %, or at least 75 wt. %, or at least 80 wt. %, or at least 85 wt. %, or at least 90 wt. %, or at least 95 wt. %, or at least 98 wt. %, based on the weight of the phenol composition used as a reactant starting material.

The phenol composition is reacted with a reactive compound such as an aldehyde at an aldehyde:phenol molar ratio (using aldehyde as an example) of greater than 1:1, or at least 1.05:1, or at least 1.1:1, or at least 1.2:1, or at least 1.25:1, or at least 1.3:1, or at least 1.35:1, or at least 1.4:1, or at least 1.45:1, or at least 1.5:1, or at least 1.55:1, or at least 1.6:1, or at least 1.65:1, or at least 1.7:1, or at least 1.75:1, or at least 1.8:1, or at least 1.85:1, or at least 1.9:1, or at least 1.95:1, or at least 2:1. The upper amount of aldehyde is not limited and can be as high as 30:1, but generally is up to 5:1, or up to 4:1, or up to 3:1, or up to 2.5:1. Typically, the ratio of aldehyde:phenol is at least 1.2:1 or more, or 1.4:1 or more or 1.5:1 or more, and typically up to 3:1. Desirably, these ratios also apply to the aldehyde/unsubstituted phenol or meta-substituted phenol ratio.

The resole phenolic resin can contain an average of at least 0.3, or at least 0.4, or at least 0.45, or at least 0.5, or at least 0.6, or at least 0.8, or at least 0.9 methylol groups per one phenolic hydroxyl group, and “methylol” includes both —CH₂OH and —CH₂OR.

The phenolic resin obtained by the condensation of phenols with aldehydes of the general formula (RCHO)n, where R is hydrogen or a hydrocarbon group having 1 to 8 carbon atoms and n is 1, 2, or 3. Examples include formaldehyde, paraldehyde, acetaldehyde, glyoxal, propionaldehyde, furfuraldehyde, or benzaldehyde. Desirably, the phenolic resin is the reaction product of phenols with formaldehyde.

At least a part of the crosslinker in (b) comprises a resole type phenolic resin that is prepared by reacting either un-substituted phenol or meta-substituted phenol or a combination thereof with an aldehyde. The unsubstituted phenol is phenol (C₆H₅OH). Examples of meta-substituted phenols include m-cresol, m-ethylphenol, m-propylphenol, m-butylphenol, moctylphenol, m-alkylphenol, m-phenylphenol, m-alkoxyphenol, 3,5-xylenol, 3,5-diethyl phenol, 3,5-dibutyl phenol, 3,5-dialkylphenol, 3,5-dicyclohexyl phenol, 3,5-dimethoxy phenol, 3-alkyl-5-alkyoxy phenol, and the like.

Although other substituted phenol compounds can be used in combination with said un-substituted phenols or meta-substituted phenols for making phenolic resins, it is desirable that at least 50%, or at least 70%, or at least 80%, or at least 90%, or at least 95%, or at least 98%, or at least 100% of the phenolic compounds used to make the resole resin are unsubstituted phenol or meta-substituted phenol.

In one aspect, the resole phenolic resin used in this invention comprises residues of m-substituted phenol.

Examples of suitable commercial phenolic resins include, but are not limited to, PHENODUR® PR 516/60B (based on cresol and formaldehyde) available from Allnex, PHENODUR® PR 371/70B (based on unsubstituted phenol and formaldehyde) also available from Allnex, and CURAPHEN 40-856 B60 (based on m-cresol, p-cresol, and formaldehyde) available from Bitrez.

The phenolic resins are desirably heat curable. The phenolic resin is desirably not made by the addition of bisphenol A, F, or S (collectively “BPA”).

The resole is desirably of the type that is soluble in alcohol. The resole resin can be liquid at 25° C. The resole resin can have a weight average molecular weight from 200 to 2000, generally from 300 to 1000, or from 400 to 800, or from 500 to 600.

In some embodiments, the crosslinker (b) is a mixture of CURAPHEN 40-856 B60 available from Bitrez and blocked isophorone diisocyanate (IPDI).

In another embodiment, the crosslinker (b) is a mixture of resole phenolic resin in an amount of 10-90 weight % and isocyanate in an amount of 90-10 weight %, based on the total weight of the crosslinkers.

Any of the thermosetting compositions of the invention can also include one or more cross-linking catalysts. Representative crosslinking catalysts include from carboxylic acids, sulfonic acids, tertiary amines, tertiary phosphines, tin compounds, or combinations of these compounds. Some specific examples of crosslinking catalysts include p-toluenesulfonic acid, phosphoric acid, the NACURE™ 155, 5076, 1051, and XC-296B catalysts sold by King Industries, BYK 450, 470, available from BYK-Chemie U.S.A., methyl tolyl sulfonimide, p-toluenesulfonic acid, dodecylbenzene sulfonic acid, dinonylnaphthalene sulfonic acid, and dinonylnaphthalene disulfonic acid, benzoic acid, triphenylphosphine, dibutyltindilaurate, and dibutyltindiacetate.

The crosslinking catalyst used in the present invention may depend on the type of crosslinker that is used in the coating composition. For example, the crosslinker can comprise an amino crosslinker and the crosslinking catalyst can comprise p-toluenesulfonic acid, phosphoric acid, unblocked and blocked dodecylbenzene sulfonic (abbreviated herein as “DDBSA”), dinonylnaphthalene sulfonic acid (abbreviated herein as “DNNSA”) and dinonylnaphthalene disulfonic acid (abbreviated herein as “DNNDSA”). Some of these catalysts are available commercially such as, for example, NACURE™ 155, 5076, 1051, 5225, and XC-296B (available from King Industries), BYK-CATALYSTS™ (available from BYK-Chemie USA), and CYCAT™ catalysts (available from Cytec Surface Specialties). The coating compositions of the invention can comprise one or more isocyanate crosslinking catalysts such as, for example, FASCAT™ 4202 (dibutyltindilaurate), FASCAT™ 4200 (dibutyltindiacetate, both available from Arkema), DABCO™ T-12 (available from Air Products) and K-KAT™ 348, 4205, 5218, XC-6212™ non-tin catalysts (available from King Industries), and tertiary amines.

The coating composition can contain an acid or base catalyst in an amount ranging from 0.1 to 2 weight %, based on the total weight of any of the aforementioned curable polyester resins and the crosslinker composition.

As a further embodiment, this invention provides a waterborne coating composition comprising:
a) the acrylic modified polyester of the present invention,
b) a neutralizing agent,
c) water, and
d) a crosslinker selected from the group comprising amino resin, isocyanate resin, and phenolic resin.

In another embodiment, the coating composition of the present invention further comprises one or more organic solvents. Suitable organic solvents include xylene, ketones (for example, methyl amyl ketone), 2-butoxyethanol, ethyl-3-ethoxypropionate, toluene, butanol, cyclopentanone, cyclohexanone, ethyl acetate, butyl acetate, Aromatic 100 and Aromatic 150 (both available from ExxonMobil), and other volatile inert solvents typically used in industrial baking (i.e., thermosetting) enamels, mineral spirits, naptha, toluene, acetone, methyl ethyl ketone, methyl isoamyl ketone, isobutyl acetate, t-butyl acetate, n-propyl acetate, isopropyl acetate, methyl acetate, ethanol, n-propanol, isopropanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate (available commercially from Eastman Chemical Company under the trademark TEXANOL™), or combinations thereof.

After formulation, the coating composition can be applied to a substrate or article. Thus, a further aspect of the present invention is a shaped or formed article that has been coated with the coating compositions of the present invention. The substrate can be any common substrate such as aluminum, tin, steel or galvanized sheeting, and the like. The coating composition can be coated onto a substrate using techniques known in the art, for example, by spraying, draw-down, roll-coating, etc., about 0.1 to about 4 mils (1 mil=25 μm), or 0.5 to 3, or 0.5 to 2, or 0.5 to 1 mils of wet coating onto a substrate. The coating can be cured at a temperature of about 50° C. to about 230° C., for a time period that ranges from about 5 seconds to about 90 minutes and allowed to cool. Examples of coated articles include metal cans for food and beverages, in which the interiors are coated with the coating composition of the present invention.

Thus, this invention further provides an article, of which at least a portion is coated with the coating composition of the present invention.

### EXAMPLES

This invention can be further illustrated by the following examples thereof, although it will be understood that these examples are included merely for purposes of illustration and are not intended to limit the scope of the invention unless otherwise specifically indicated.

### Coating Test Methods:

### Substrate, Coated Test Panel Preparation, Film Weight

Chromium (Cr³⁺) treated aluminum panels with 0.125 mm in thickness were used as the substrates. The substrates were coated by casting wet films with wire wound rods yielding a dry film weight of 10 to 11 grams/m². The cast panels were cured horizontally one at a time in an oven. A Despatch forced air oven was preheated to a setting temperature of 350° C. A coated panel was placed into the oven for 28 sec of bake cycle time in order to allow the coating to be bake at 240° C. Peak Metal Temperature (PMT) for 10 sec. At the conclusion of the baking cycle, the panel was removed from the oven and allowed to cool to ambient temperature. A Sencon S19600 coating thickness gauge was used to confirm the dry film weight of the applied coatings.

### Reverse Impact Test

A coupon measuring 3″ wide×8″ long was cut from a coated panel. On the reverse side of the panel (uncoated side) a template was used to draw 3 test squares well distributed down the center of the panel. Marked the central point of each square to know where to direct point of impact. Aligned central point of square below 21b dart and released from height of 11 cm. After completing all the panels, applied a piece of tape Scotch® Packaging Tape 610 vertically across the impact zone on the coated side of the panel (ensured secure contact before promptly and quickly removing). As the tape was removed, adhered it to the back of the panel next to the impact zone it was removed from. Used a paper towel saturated in 5% copper sulfate solution to blot impact zone to help highlight where adhesion loss occurred, and the substrate was exposed. Evaluated panels for adhesion loss and rated using 1-5 scale with those exhibiting a 5 having the best performance.

### Methyl Ethyl Ketone (MEK) Double Rubs

The resistance to MEK solvent was measured using a MEK rub test machine (Gardco MEK Rub Test Machine AB-410103EN with 1 kg block). This test was carried out similar to ASTM D7835. MEK solvent resistance was reported as the number of double rubs a coated panel can withstand before the coating starts to be removed. For example, one back-and-forth motion constitutes one double rub. A maximum of 100 double rubs was set as the upper limit for each evaluation.

### Sterilization Resistance Testing

A coated coupon measuring 2.5″ wide×4″ long was cut from the coated panel. The coupons were then placed in a 16 oz wide mouth Le Parfait glass jar half filled with the food simulant where half the coupon was above the food simulant liquid and the other half was submerged in food simulant liquid. Two different food simulants were evaluated:
Citric Acid: 1% lactic acid, 99% deionized water.
Deionized (DI) Water

The jars with properly closed top were placed in an autoclave, Priorclave Model PNA/QCS/EH150, for 30 min at 121° C. Once the retort process was finished, the autoclave was allowed to depressurize to ambient conditions. After the completion of sterilization cycle, the glass jars containing the test coupons were then removed from the autoclave. The coupons were removed from the jars and washed under water and blotted dry with paper towels. The retort performance was rated on a scale of 0 (worst) to 5 (best) using a visual observation. For each food simulant, the retort performance was rated on (1) blush at vapor phase, (2) blush at liquid phase, (3) roughness at vapor phase, (4) roughness at liquid phase and (5) cross-hatch adhesion (following ASTM D 3359) at liquid phase, respectively. An overall retort performance is reported as Total Retort % calculated by:

$$Total Retort \% = \frac{\begin{matrix}Sum of rating ( 1 ) to ( 5 ) from 1 \% citric acid + \\ Sum of rating ( 1 ) to ( 5 ) from 3 \% DI water\end{matrix}}{50} \times 100 \%$$

Each retort rating in this experiment is an average rating from 2 replicates.

### Comparative Example 1: Branched Resins in which AN is Obtained Inherently in Synthesis

The polyols were produced using a resin kettle reactor setup controlled with automated control software. The compositions were produced on a 3.5-4.5 mole scale using a 2 L kettle with overhead stirring and a partial condenser topped with total condenser and Dean Stark trap. Approximately 10 wt % (based on reaction yield) azeotroping solvent of high boiling point Aromatic 150 ND (A150ND, available from ExxonMobile) was used to both encourage egress of the water condensate out of the reaction mixture and keep the reaction mixture viscosity at a reasonable level using the standard paddle stirrer. Isophthalic acid (IPA), terephthalic acid (TPA), 1,4-cyclohexane dimethanol (CHDM), 2,2,4,4-tetramethyl-cyclobutanediol (TMCD), 2-methyl-1,3-propanediol (MPdiol), trimethylolpropane (TMP), and 0-10 wt % A150ND were added to the reactor, which was then completely assembled. Fascat 4100 (monobutyltin oxide, available from PMC Organometallix Inc.) or Fascat 2003 (stannous octoate, available from PMC Organometallix Inc.) was added via the sampling port after the reactor had been assembled and blanketed with nitrogen for the reaction. Additional A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was sufficiently fluid, the stirring was started to encourage even heating of the mixture. At 150° C., the control of heating was switched to automated control and the temperature was ramped to 200° C. over the course of 3 h. The reaction was held at 200° C. for 1 h and then heated to 240° C. at a rate of 0.3 degrees/m. The reaction was then held at 240° C. and sampled every 1-2 h upon clearing until the desired acid value for Stage 1 was reached. An overnight hold temperature of 150° C. was utilized, and any additional A150ND necessary to reach the desired ˜10 wt % was added at 150° C. prior to reheating to the reaction temperature. Upon reaching the Stage 1 target acid value, the reaction mixture was cooled to 190° C., and 4-Methoxyphenol (MeHQ, 1% by weight based on MA) was added and allowed to stir for 15 m. Next, maleic anhydride (MA) was added to the reaction mixture and heated to 220-230° C. at 1.5° C./m. The acid value was monitored every 30-60 m until the final desired acid value was reached. The reaction mixture was either poured out into an aluminum pan to be broken up or further diluted with Dowanol DPM glycol ether (DPM, available from Dow Inc.) to target a weight percent solids of 60%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the desired molecular weight, OHN, and AN. An example of a basic charge sheet is provided below.

Glass transition temperature (Tg) was determined using a Q2000 differential scanning calorimeter (DSC) from TA Instruments, New Castle, DE, US, at a scan rate of 20° C./min. Number average molecular weight (Mn) and weight average molecular weight (Mw) were measured by gel permeation chromatography (GPC) using polystyrene equivalent molecular weight and THF or 95/5 CH₂Cl₂/HFIP solvent. Acid number was measured by using a procedure based on ASTM D7253-1 entitled “Standard Test Method for Polyurethane Raw Materials: Determination of Acidity as Acid Number for Polyether Polyols,” and hydroxyl number was measured using a procedure based on ASTM E222-1 entitled “Standard Test Methods for Hydroxyl Groups Using Acetic Anhydride.

TABLE 1
Charge

| | | | | Charge | |
|---|---|---|---|---|---|
| | | | | Weight | |
| Raw | | | | (including | % |
| Material | Moles | Equivalents | Weight | excess) | Excess |
| Stage 1 | | | | | |
| IPA | 2.6950 | 5.3900 | 447.72 | 447.72 | 0 |
| TPA | 0.5250 | 1.0500 | 87.22 | 87.22 | 0 |
| TMCD | 1.4239 | 2.8478 | 205.34 | 221.77 | 8 |
| 1,4-CHDM | 0.8899 | 1.7799 | 128.34 | 129.62 | 1 |
| MP Diol | 1.1747 | 2.3495 | 105.84 | 106.90 | 1 |
| TMP | 0.0712 | 0.2136 | 9.55 | 10.03 | 5 |
| Stage 2 | | | | | |
| MA | 0.2800 | 0.5600 | 27.46 | 27.46 | 0 |
| | | Total Charge | 1011.47 | | |
| | | Minus Condensate | 119.72 | | |
| | | Yield | 891.75 | | |
| (Catalyst) | Concentration | | | | |
| Fascat 2003 | 400 | | | 1.42 | |
| (Processes Solvent) | Wt. % | | | | |
| A150ND | 10 | | | 114.68 | |
| (Radical inhibitor) | Wt. % on MA | | | | |
| MeHQ | 1 | | | 0.27 | |
| (Processes Solvent) | Final Wt. % | | | | |
| DPM | 60 | | | 493.60 | |

### Example 1: Synthesis of TMA Modified Unsaturated Polyester

The polyester was produced using a resin kettle reactor setup controlled with automated control software. The composition was produced on a 3.5-4.5 mole scale using a 2 L kettle with overhead stirring and a partial condenser topped with total condenser and Dean Stark trap. Approximately 10 wt % (based on reaction yield) azeotroping solvent of high boiling point Aromatic 150ND (A150ND, available from ExxonMobile) was used to both encourage egress of the water condensate out of the reaction mixture and keep the reaction mixture viscosity at a reasonable level using the standard paddle stirrer. Isophthalic acid (IPA), terephthalic acid (TPA), 1,4-cyclohexane dimethanol (CHDM), 2,2,4,4-tetramethyl-cyclobutanediol (TMCD), 2-methyl-1,3-propanediol (MPdiol), trimethylolpropane (TMP), and 0-10 wt % A150ND were added to the reactor, which was then completely assembled. Fascat 4100 (monobutyltin oxide, available from PMC Organometallix Inc.) or Fascat 2003 (stannous octoate, available from PMC Organometallix Inc.) was added via the sampling port after the reactor had been assembled and blanketed with nitrogen for the reaction. Additional A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was sufficiently fluid, the stirring was started to encourage even heating of the mixture. At 150° C., the control of heating was switched to automated control and the temperature was ramped to 200° C. over the course of 3 h. The reaction was held at 200° C. for 1 h and then heated to 240° C. at a rate of 0.3 degrees/m. The reaction was then held at 240° C. and sampled every 1-2 h upon clearing until the desired acid value for Stage 1 was reached. An overnight hold temperature of 150° C. was utilized, and any additional A150ND necessary to reach the desired ˜10 wt % was added at 150° C. prior to reheating to the reaction temperature. Upon reaching the Stage 1 target acid value, the reaction mixture was cooled to 190° C., and 4-Methoxyphenol (MeHQ, 1% by weight based on MA) was added and allowed to stir for 15 m. Next, maleic anhydride (MA) was added to the reaction mixture and heated to 220-230° C. at 1.5° C./m. The acid value was monitored every 30-60 m until the final desired acid value was reached (AN<1). Next, two methods could be used for the addition of trimellitic anhydride (TMA).

In one case, the kettle reaction was poured out into an aluminum pan to be broken up for later reaction with TMA. In this case, TMA and the isolated reaction mixture were charged to a 500 mL round-bottom flask equipped with a mechanical stirrer and polymer head with nitrogen inlet. This reaction mixture was stirred with an overhead stirrer at 180° C. for 2 h, and the viscous resins were either poured into an aluminum pan or reduced using DPM and poured into a glass jar.

In the other case, the whole reaction mixture remained in the kettle, and the temperature was reduced to 180° C. at which point TMA was charged to the kettle via the sampling port and a small amount of A150 was used to wash any remaining TMA from the sample port walls. The reaction mixture stirred for 2 h at 180° C. before being poured out into an aluminum pan to be broken up or further diluted with Dowanol DPM glycol ether (DPM, available from Dow Inc.) to target a weight percent solids of 60%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the desired molecular weight. An example of a basic charge sheet is provided below.

Glass transition temperature (Tg) was determined using a Q2000 differential scanning calorimeter (DSC) from TA Instruments, New Castle, DE, US, at a scan rate of 20° C./min. Number average molecular weight (Mn) and weight average molecular weight (Mw) were measured by gel permeation chromatography (GPC) using polystyrene equivalent molecular weight and THF or 95/5 CH₂Cl₂/HFIP solvent. Acid number was measured by using a procedure based on ASTM D7253-1 entitled “Standard Test Method for Polyurethane Raw Materials: Determination of Acidity as Acid Number for Polyether Polyols,” and hydroxyl number was measured using a procedure based on ASTM E222-1 entitled “Standard Test Methods for Hydroxyl Groups Using Acetic Anhydride.

TABLE 2
Charge

| | | | | Charge | |
|---|---|---|---|---|---|
| | | | | Weight | |
| | | | | (including | % |
| Raw Material | Moles | Equivalents | Weight | excess) | Excess |
| Stage 1 | | | | | |
| IPA | 2.6950 | 5.3900 | 447.72 | 447.72 | 0 |
| TPA | 0.5250 | 1.0500 | 87.22 | 87.22 | 0 |
| TMCD | 1.4561 | 2.9121 | 209.98 | 226.78 | 8 |
| 1,4-CHDM | 0.9100 | 1.8201 | 131.24 | 132.55 | 1 |
| MP Diol | 1.2013 | 2.4025 | 108.23 | 109.32 | 1 |
| TMP | 0.0728 | 0.2184 | 9.77 | 10.26 | 5 |
| Stage 2 | | | | | |
| MA | 0.2800 | 0.5600 | 27.46 | 27.46 | 0 |
| | | Total Charge | 1021.61 | | |
| | | Minus Condensate | 121.09 | | |
| | | Yield | 900.52 | | |
| Stage 3 | | | | | |
| TMA | 0.0401 | | | 7.71 | 0 |
| (Catalyst) | Concentration | | | | |
| Fascat 2003 | 400 | | | 1.44 | |
| (Processes Solvent) | Wt. % | | | | |
| A150ND | 10 | | | 115.86 | |
| (Radical inhibitor) | Wt. % on MA | | | | |
| MeHQ | 1 | | | 0.27 | |
| (Processes Solvent) | Final Wt. % | | | | |
| DPM | 60 | | | 498.57 | |

For every resin in Tables 4 and 5, the charged composition is shown in Table 3, omitting TMP and MPD levels, which are imbedded into the design parameters

TABLE 3
Monomer levels held constant in Table 4 and Table 5 resins.

| IPA | TPA | MA | TMCD | CHDM |
|---|---|---|---|---|
| (mol % on | (mol % on | (mol % on | (mol % on | (mol % on |
| acids) | acids) | acids) | glycols) | glycols) |
| 77 | 15 | 8 | 40 | 25 |

TABLE 4
Resin Properties of Polyesters without TMA modification.

| | TMP | MPD | | | | | | |
|---|---|---|---|---|---|---|---|---|
| | (mol % on | (mol % on | AN | OHN | Mn | Mw | | Tg |
| Resin # | glycols) | glycols) | (mg KOH/g) | (mg KOH/g) | (g/mol) | (g/mol) | PD | (° C.) |
| PE-1 | 2 | 33 | <1 | 27 | 9528 | 29921 | 3.1 | 81 |
| PE-2 | 2 | 33 | <1 | 25 | 10283 | 37460 | 3.6 | 72 |
| PE-3 | 2 | 33 | <1 | 26 | 9481 | 30288 | 3.2 | 76 |
| PE-4 | 2 | 33 | <1 | 27 | 9233 | 30015 | 3.3 | 78 |
| PE-5 | 4 | 31 | <1 | 24 | 11957 | 127875 | 11 | 80 |
| PE-6 | 4 | 31 | <1 | 28 | 10134 | 57534 | 5.7 | 79 |
| PE-7 | 4 | 31 | <1 | 36 | 8800 | 34039 | 3.9 | 77 |
| PE-8 | 4 | 31 | <1 | 36 | 8723 | 35188 | 4.0 | 76 |
| PE-9 | 4 | 31 | <1 | 36 | 8737 | 35066 | 4.0 | 78 |

TABLE 5
Resin Properties of Polyesters Modified with TMA.

| | TMP | MPD | | | | | | | | Target |
|---|---|---|---|---|---|---|---|---|---|---|
| | (mol % on | (mol % on | Initial OHN | Initial AN | Final AN | Final OHN | Mn | Mw | | Tg |
| Resin # | glycols) | glycols) | (mg KOH/g) | (mg KOH/g) | (mg KOH/g) | (mg KOH/g) | (g/mol) | (g/mol) | PD | (° C.) |
| PE-1T | 2 | 33 | 27 | <1 | 5 | 23 | 8720 | 31735 | 3.6 | 80 |
| PE-2T | 2 | 33 | 25 | <1 | 10 | 18 | 8630 | 40535 | 4.7 | 71 |
| PE-3T | 2 | 33 | 26 | <1 | 13 | 13 | 7389 | 30985 | 4.2 | 81 |
| PE-4T | 2 | 33 | 27 | <1 | 18 | 16 | 6573 | 83063 | 4.5 | 82 |
| PE-5T | 4 | 31 | 24 | <1 | 4 | 19 | 11435 | 182998 | 16 | 83 |
| PE-6T | 4 | 31 | 28 | <1 | 9 | 21 | 9042 | 77151 | 8.5 | 83 |
| PE-7T | 4 | 31 | 36 | <1 | 14 | 25 | 6997 | 36136 | 5.2 | 84 |
| PE-8T | 4 | 31 | 36 | <1 | 18 | 22 | 6680 | 40950 | 6.1 | 88 |
| PE-9T | 4 | 31 | 36 | <1 | 27 | 17 | 5643 | 34783 | 6.2 | 91 |

### Example 2: Synthesis of Acrylic-Modified Polyester Resin

In a heated 500 ml round-bottom flask equipped with a water condenser was dissolved 100 g of the polyester resin from Example 1 in 62 g of DOWANOL DPM glycol ether. After cooling, the flask was charged with the following compounds: methyl methacrylate (5.5 g), ethyl methacrylate (5.5 g), methacrylic acid (6 g), and 2-hydroxyethyl methacrylate (3 g). The mixture was then heated to about 120° C. and stirred under nitrogen atmosphere. A suspension of initiator, tert-butyl peroctoate (2.8 g), in DOWANOLDPM glycol ether (3.3 g) was prepared. This initiator suspension was added to the reaction mixture over 1 hour and then held at 120° C. for 2 hours. The reaction mixture was then cooled to below 100° C.

### Example 3: Preparation of Aqueous Dispersions of Acrylic Modified Polyesters

Each polymer solution prepared in Example 2 was charged to a 500 mL three-necked round bottom flask and heated to 80° C., followed by the addition of N,N-dimethylethanolamine as the neutralizing agent (80-100% neutralization). Water was gradually added until a homogeneous dispersion is obtained (30-50% solids). The mixture was allowed to cool to room temperature. The resulting dispersion was filtered and collected.

### Example 4: Preparation of Coating Formulations

In lieu of waterborne formulations, solvent-borne formulations were prepared and tested for cured film properties. It is expected that the coating properties of reverse impact, MEK double rubs, and total retort reported herein are close simulation of the waterborne formulations. Prior to formulating, all acrylic-modified polyester resins were diluted in ShellSol A150 ND (aromatic solvents available from Shell Chemicals) to 50 wt. % solids. The solvent blends were made from the mixture of xylene, butanol and MAK at 30%, 30% and 40% by weight, respectively. An empty glass jar with a lid was labeled and pre-weighted to record the tare weight. For each formulation, Maprenal® BF 987 (n-butylated benzoquanamine-formaldelhyde resin available commercially from Ineos), Cymel 325 (melamine-formaldelhyde resin available from Allnex), Lanco™ Glidd 4415 Wax Dispersion available from Lubrizol, Nacure® 5076 (DDBSA acid catalyst available from King Industries), and the solvent blend were weighed out respectively and added to the resin solution in order. The formulation was then sheared for 10-15 minutes at 1500 RPMs with a Cowles blade on a Dispermat™ high speed disperser. Once it was completed, the glass jar containing the formulation was then rolled overnight with slight agitation at ambient conditions. The coating formulations thus prepared are listed in Table 6.

TABLE 6
Coating Formulations based on Acrylic-Modified Resins.

| | Solids/ | F-1 | F-2 | F-3 |
|---|---|---|---|---|
| | Active | Weight | Weight | Weight |
| Component | % | (g) | (g) | (g) |
| Acrylic-modified Resin PE-1T | 50% | 33.75 | | |
| Acrylic-modified Resin PE-6T | 50% | | 33.75 | |
| Acrylic-modified Resin PE-7T | 50% | | | 33.75 |
| Maprenal BF 987 | 74% | 4.56 | 4.56 | 4.56 |
| Cymel ® 325 | 80% | 2.81 | 2.81 | 2.81 |
| Lanco ™ Glidd 4415 | 15% | 1.00 | 1.00 | 1.00 |
| BYK ®-392 | 52% | 0.10 | 0.10 | 0.10 |
| Nacure ® 5076 in butanol | 10% | 0.45 | 0.45 | 0.45 |
| Solvent Blend (Xylene, Butanol, | 0% | 7.33 | 7.33 | 7.33 |
| MAK 30/30/40) | | | | |

| | | | |
|---|---|---|---|
| Total | 50.00 | 50.00 | 50.00 |

Calculation:

| | | | |
|---|---|---|---|
| % Total solids | 45.00% | 45.00% | 45.00% |
| % Polyester polyol on total binder | 75.00% | 75.00% | 75.00% |
| % Benzoguanamine on total binder | 15.00% | 15.00% | 15.00% |
| % Melamine on total binder | 10.00% | 10.00% | 10.00% |
| % DDBSA catalyst on binder | 0.20% | 0.20% | 0.20% |

### Example 5: Coating Preparation and Testing

The solvent-borne formulations prepared from Example 4 were applied on metal substrates such as chromium-treated aluminum. The panels were cured at an elevated temperature, for example, at 350° C. for 28 sec. Coatings thus obtained were then tested for their properties such as reverse impact, MEK double rubs, and total retort in accordance with the test methods described above. The results are listed in Table 7.

TABLE 7
Coating Properties

| | | | MEK | Total |
|---|---|---|---|---|
| | Film | Reverse | Double | Retort |
| Examples | Apperance | Impact | Rubs | % |
| F1 | OK | 3.5 | 100+ | 99% |
| F2 | OK | 4.5 | 97 | 100% |
| F3 | OK | 5.0 | 95 | 100% |

The invention has been described in detail with reference to the embodiments disclosed herein, but it will be understood that variations and modifications can be effected within the spirit and scope of the invention.

1. A waterborne coating composition comprising:
I. an acrylic modified polyester, which is the reaction product of
a. an unsaturated polyester having α,β-unsaturated moieties prepared by reacting the monomers comprising:
i. 2,2,4,4-tetramethyl-1,3-cyclobutanediol (TMCD) in an amount of 30 to 60 mole %, based on the total moles of i-iii,
ii. a diol other than TMCD in an amount of 40 to 70 mole %, based on the total moles of i-iii,
iii. a triol in an amount of 0 to 8 mole %, based on the total moles of i-iii,
iv. an α,β-unsaturated diacid or anhydride in an amount of 1 to 20 mole %, based on the total moles of iv-vii,
v. an aromatic diacid in an amount of 45 to 98 mole %, based on the total moles of iv-vii,
vi. an aliphatic diacid in an amount of 0 to 20 mole %, based on the total moles of iv-vii, and
vii. trimellitic anhydride (TMA) in an amount of 1 to 15 mole %, based on the total moles of iv-vii, and
b. one or more ethylenically unsaturated monomers
II. a crosslinker,
wherein said unsaturated polyester has an acid number of 5 to 30 mgKOH/g, hydroxyl number of 6 to 30 mgKOH/g, number average molecular weight of 4,000 to 25,000 g/mole, and weight average molecular weight of 13,000 to 200,000 g/mole; and wherein said unsaturated polyester is reacted with said ethyleneically unsaturated monomers through said α,β-unsaturated moieties.

2. The waterborne coating composition of claim 1, wherein said 2,2,4,4-tetramethyl-1,3-cyclobutanediol (TMCD) (i) is in an amount of 35-58 mole %, said diol other than TMCD (ii) in an amount of 42 to 65 mole %, said triol (iii) in an amount of 0 to 5 mole %, said α,β-unsaturated diacid or anhydride (iv) in an amount of 3 to 18 mole, said aromatic diacid (v) in an amount of 54 to 94 mole %, said aliphatic diacid (vi) in an amount of 0 to 15 mole %, and said TMA in an amount of 3-13 mole %.

3. The waterborne coating composition of claim 1, said 2,2,4,4-tetramethyl-1,3-cyclobutanediol (TMCD) (i) is in an amount of 40-50 mole %, said diol other than TMCD (ii) in an amount of 50 to 60 mole %, said triol (iii) in an amount of 0 to 3 mole %, said α,β-unsaturated diacid or anhydride (iv) in an amount of 5 to 15 mole, said aromatic diacid (v) in an amount of 65 to 90 mole %, said aliphatic diacid (vi) in an amount of 0 to 10 mole %, and said TMA in an amount of 5-10 mole %.

4. The waterborne coating composition of claim 1, wherein said diol other than TMCD (ii) is one or more selected from 1,4-cyclohexanedimethanol, 1,3-cyclohexanedimethanol, 1,6-hexanediol, 2-methyl-1,3-propanediol, neopentyl glycol, and 2,2,4-trimethyl-1,3-pentanediol.

5. The waterborne coating composition of claim 1, wherein said triol (iii) is trimethylolpropane.

6. The waterborne coating composition of claim 1, wherein said α,β-unsaturated diacid or anhydride (iv) is one or more selected from the group comprising maleic anhydride, maleic acid, fumaric acid, itaconic anhydride, and itaconic acid.

7. The waterborne coating composition of claim 1, wherein said aliphatic diacid (vi) is one or more selected from succinic acid, adipic acid, sebacic acid, 1,4-cyclohexane dicarboxylic acid, and 1,3-cyclohexane dicarboxylic acid.

8. The waterborne coating composition of claim 1, wherein said aliphatic diacid (vi) is sebacic acid, adipic acid, or a mixture thereof.

9. The waterborne coating composition of claim 1, wherein said polycarboxylic acid anhydride has one or more carboxylic acid groups in addition to an anhydride group.

10. The waterborne coating composition of claim 1, wherein said unsaturated polyester (a) has a hydroxyl number of 6-25 mgKOH/g.

11. The coating composition of claim 1, wherein said unsaturated polyester (a) has an acid number of 6-25 mgKOH/g.

12. The waterborne coating composition of claim 1, wherein said unsaturated polyester (a) has a Tg of 40-110° C.

13. The waterborne coating composition of claim 1, wherein said unsaturated polyester (a) is made by using a titanium catalyst.

14. The waterborne coating composition of claim 1, wherein said ethylenically unsaturated monomers are selected from the group comprising acrylic acid, methacrylic acid, methyl methacrylate, methyl acrylate, ethyl methacrylate, ethyl acrylate, n-butyl acrylate, 2-ethylhexyl acrylate, 2-hydroxyethyl methacrylate, and styrene.

15. The waterborne coating composition of claim 1, wherein said unsaturated polyester (a) in an amount of 10-90 weight % and said ethylenically unsaturated monomers (b) in an amount of 90-10, based on the total weight of (a) and (b).

16. The waterborne coating composition of claim 1, wherein said acrylic modified polyester has an acid number of 25-70 mgKOH/g and hydroxyl number of 15-50 mgKOH/g,

17. The waterborne coating composition of claim 1, wherein said coating composition further comprises a neutralizing agent and water.

18. The waterborne coating composition of claim 1, wherein said crosslinker is one or more selected from isocyanate, amino resin, and phenolic resin crosslinkers.

19. The waterborne coating composition of claim 1, wherein said acrylic modified polyester (a) in an amount of 50-90 weight % and said crosslinker (b) in an amount of 10-50 weight %, based on the total weight of (a) and (b).

20. An article, of which at least a portion is coated with the waterborne coating composition of claim 1.
